(19) United States
(12) Patent Application Publication
(10) Pub. No.: US 2026/0066445 A1
(43) Pub. Date: Mar. 5, 2026

(54) SECONDARY BATTERY

(71) Applicant: SAMSUNG SDI CO., LTD., Yongin-si (KR)

(72) Inventor: Jae Il SEONG, Yongin-si (KR)

(21) Appl. No.: 19/011,891

(22) Filed: Jan. 7, 2025

(30) Foreign Application Priority Data
Aug. 30, 2024 (KR) 10-2024-0117424

(51) Int. Cl. H01M 50/342; H01M 50/107

(52) U.S. Cl. CPC H01M 50/3425; H01M 50/107; H01M 2220/20

(57) ABSTRACT

Disclosed is a secondary battery capable of controlling a gas discharge direction. Gas discharged to outside of the battery through a cap up may be guided in a desired direction, whereby it is possible to attach a sensor to a desired position to avoid gas discharge. In addition, it is possible to control the direction of the recoil from the discharging gas, thereby preventing and controlling problems such as damage caused by the recoil.

### CROSS-REFERENCE TO THE RELATED APPLICATION

The present application claims priority to and the benefit of Korean Patent Application No. 10-2024-0117424, filed on Aug. 30, 2024, in the Korean Intellectual Property Office, the entire disclosure of which is incorporated herein by reference.

### BACKGROUND

### 1. Field

Embodiments of the present disclosure relate to a secondary battery.

### 2. Description of the Related Art

Unlike primary batteries that are not designed to be (re) charged, secondary (or rechargeable) batteries are batteries that are designed to be discharged and recharged. Low-capacity secondary batteries are used in portable small electronic devices, such as smart phones, feature phones, notebook (laptop) computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The information disclosed in this section is provided only for enhancement of understanding of the background of the disclosure and therefore it may contain information that does not constitute related (or the prior) art.

### SUMMARY

Embodiments of the present disclosure provide a secondary battery capable of controlling a gas discharge direction.

These and other aspects and features of the present disclosure will be described in or will be apparent from the following description of embodiments of the present disclosure.

A secondary battery according to an embodiment of the present disclosure a cylindrical can, an electrode assembly accommodated in the can, and a cap assembly including a cap up exposed to outside of the can, a vent plate disposed under the cap up, at least a part of the vent plate being coupled to the cap up, and a cap down disposed under the vent plate, a part of the cap down being electrically connected to the vent plate and the electrode assembly, the cap assembly being coupled to an end of the can, wherein a plurality of discharge holes is formed through at least one surface of the cap up so as to face in at least one direction.

The vent plate may be shaped to wrap around an edge of the cap up.

The cap up may include a first region in contact with the vent plate, a second region protruding outward from the first region, and a third region provided between the first region and the second region, the third region being inclined relative to the first region and the second region.

The discharge holes may be provided in the second region.

The discharge holes are formed in diagonal directions that are diagonal relative to a surface of the upper cap and are opposite to each other.

The discharge holes are formed in the same direction and diagonal relative to a surface of the cap up.

The discharge holes may be provided in the third region.

The discharge holes may be formed angles relative to a direction that is normal to a surface of the second region.

The discharge holes may be formed so as to face upwardly from the cap up.

The discharge holes may be formed parallel to a direction that is normal to a surface of the second region.

A secondary battery according to another embodiment of the present disclosure includes can having a circular bottom portion and a cylindrical side portion extending from the bottom portion, the can having an open end opposite to the circular bottom portion, and a cap assembly including a cap up exposed to outside of the can, a vent plate disposed under the cap up, at least a part of the vent plate being coupled to the cap up, and a cap down disposed under the vent plate, a part of the cap down being electrically connected to the vent plate and the electrode assembly, the cap assembly being coupled to the side portion at the open end of the case, wherein a plurality of discharge holes is formed through at least one surface of the cap up of the cap assembly so as to face in at least one direction.

The vent plate may be shaped to wrap around an edge of the cap up.

The cap up may include a first region in contact with the vent plate, a second region protruding outward from the first region, and a third region provided between the first region and the second region, the third region being inclined relative to the first region and the second region.

The discharge holes may be provided in the second region.

The discharge holes may be formed at angles relative to a direction that is normal to a surface of the second region of the cap up and in directions that are opposite to each other.

The discharge holes may be formed in the same direction and at an angle relative to a direction that is normal to a surface of the second region.

The discharge holes may be provided in the third region.

The discharge holes may be formed at angles relative to a direction that is normal to a surface of the second region.

The discharge holes may be formed so as to face upwardly from the cap up.

The discharge holes may be formed parallel to a direction that is normal to a surface of the second region.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a perspective view showing a secondary battery according to an embodiment of the present disclosure;

FIG. 2 is a sectional view of the secondary battery shown in FIG. 1;

FIG. 3 is an enlarged sectional view of a cap assembly shown in FIG. 2;

FIGS. 4 to 6 are enlarged sectional views of cap assemblies according to other embodiments of the present disclosure;

FIGS. 7 and 8 are perspective views showing a battery pack including an exemplary secondary battery according to the present disclosure.

FIGS. 9 and 10 are perspective and side views of a vehicle including an exemplary battery pack according to the present disclosure.

### DETAILED DESCRIPTION OF EXEMPLARY EMBODIMENTS

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Additionally, in order to facilitate understanding of the invention, the attached drawings are not drawn to scale and the dimensions of some components may be exaggerated. Additionally, the same reference numbers may be assigned to the same components in different embodiments.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in this specification are for describing embodiments of the present disclosure and are not intended to limit the disclosure.

Hereinafter, a secondary battery according to embodiments of the present disclosure will be described in detail with reference to the accompanying drawings.

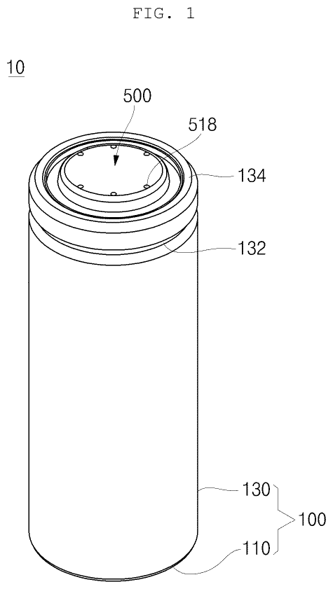

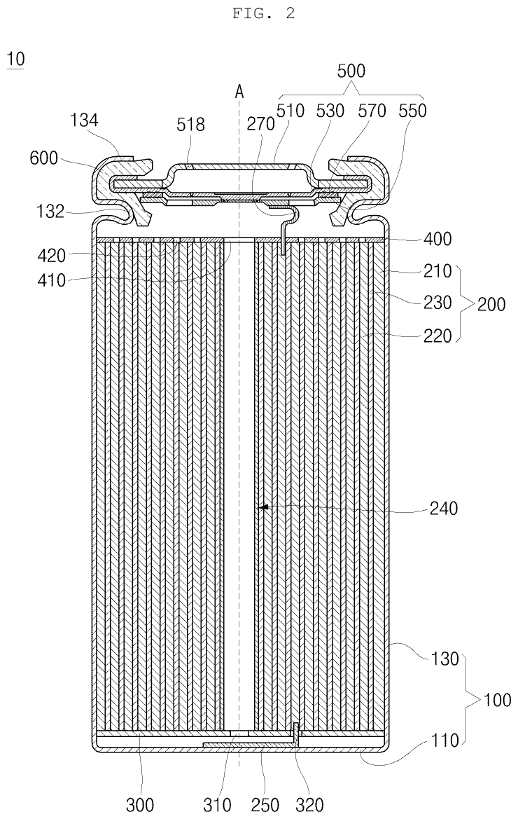

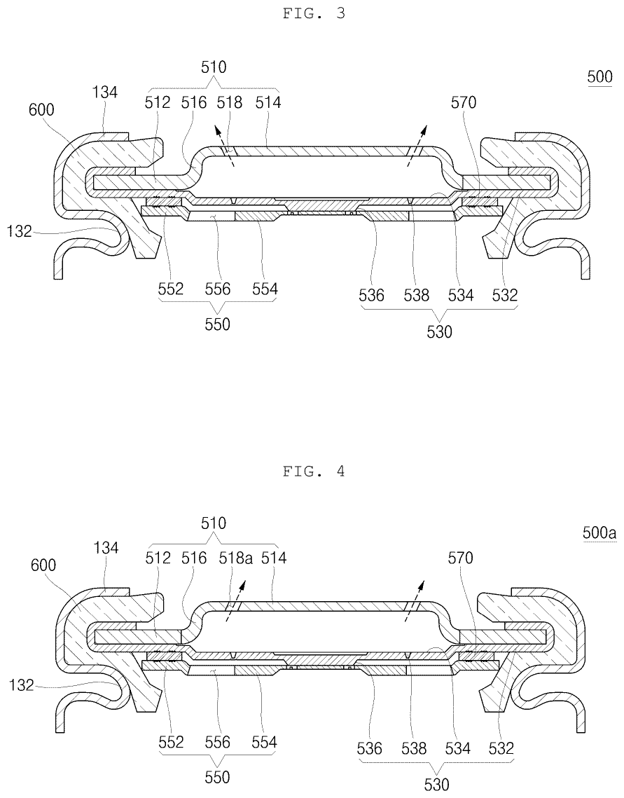

FIG. 1 is a perspective view showing a secondary battery according to an embodiment of the present disclosure. FIG. 2 is a sectional view of the secondary battery shown in FIG. 1. FIG. 3 is an enlarged sectional view of a cap assembly shown in FIG. 2.

Referring to FIGS. 1 to 3, the secondary battery 10 according to an embodiment of the present disclosure may be a cylindrical battery. The secondary battery 10 may include a can 100, an electrode assembly 200, a first insulating plate 300, a second insulating plate 400, a cap assembly 500, and an insulating gasket 600. The electrode assembly 200 may be electrically connected to the can 100 and the cap assembly 500 via a first electrode tab 250 and a second electrode tab 270, respectively.

The can 100 constitutes the exterior of the secondary battery 10. The can 100 may have a cylindrical shape and be open at one end. The can 100 may include or be referred to as a case, housing, or cladding. The can 100 may be made of a metal, such as steel, nickel-plated steel, a steel alloy, aluminum, an aluminum alloy, or cold rolled deep drawing steel plate (SPCE), or a laminated film or plastic material constituting a pouch. The can 100 may include a circular bottom portion 110 and a cylindrical side portion 130 extending upward from the bottom portion 110. An upper end of the side portion 130 may be open, and the cap assembly 500 may be coupled to the open end. In addition, a beading part 132 and a crimping part 134 may be provided at the upper end of the side portion 130. Although the present embodiment is described based on an example where the top of the can 100 is open, the bottom of the can 100 may also be open. The electrode assembly 200 may be received in the can 100 together with an electrolyte. In addition, the first insulating plate 300 and the second insulating plate 400 may be disposed on the top and bottom of the electrode assembly 200, respectively.

The beading part 132 may be adjacent to an end of the side portion 130 and may be recessed inward. The crimping part 134 may be spaced apart from the beading part 132 and may be formed by inwardly bending the end of the side portion 130. The cap assembly 500, which will be described later, may be disposed between the beading part 132 and the crimping part 134. Thus, the beading part 132 and the crimping part 134 may secure the cap assembly 500 to prevent the cap assembly 500 from being separated from the can 100. At this time, the cap assembly 500 may be insulated from the can 100 by an insulating gasket 600.

The electrode assembly 200 may include or be referred to as an electrode group, electrode body, or jelly-roll. The electrode assembly 200 may include a first electrode plate 210, a second electrode plate 220, and a separator 230. In the electrode assembly 200, the separator 230 may be interposed between the first electrode plate 210 and the second electrode plate 220, which may be wound into a columnar shape. In some examples, the electrode assembly 200 may have a substantially hollow central region. The hollow central region may also be referred to as a core 240.

An optional cylindrical center pin for support may be inserted into the core 240. The core 240 may serve as a passage for gas to escape if the internal pressure of the secondary battery 10 is greater than a reference pressure. In some examples, an increase in the internal pressure may cause gas to rise through the core 240 and break a notch 538 in a vent plate 530, which will be described later. The gas may escape through a cap up 510, which will be described later, thereby reducing the internal pressure of the secondary battery 10.

The first electrode plate 210 may be either a negative electrode plate and a positive electrode plate. The first electrode plate 210 may include a first substrate, which may be a thin sheet of metal, a first active material layer provided on at least one surface of the first substrate, and a first uncoated portion provided with no first active material. The first uncoated portion may be referred to as the first substrate. The first electrode tab 250 may be electrically connected to the first uncoated portion. In a case where the first electrode tab 250 functions as a negative electrode tab, the first electrode tab 250 may be made of copper or nickel.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, Siox (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move. The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The second electrode plate 220 may be either a negative electrode plate and a positive electrode plate. The second electrode plate 220 may include a second substrate, which may be a thin sheet of metal, a second active material layer provided on at least one surface of the second substrate, and a second uncoated portion provided with no second active material. The second uncoated portion may be referred to as the second substrate. The second electrode tab 270 may be electrically connected to the second uncoated portion. When the second electrode plate 220 functions as a positive electrode, the second electrode tab 270 may function as a positive electrode tab. The second electrode tab 270 may be made of aluminum.

Meanwhile, as the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiaA1-bXbO2-cDc (0.90≤a≤1.8, 0≤b≤0.5, 0≤c≤0.05); LiaMn2-bXbO4-cDc (0.90≤a≤1.8, 0≤b≤0.5, 0≤c≤0.05); LiaNi1-b-cCobXcO2-αDα (0.90≤a≤1.8, 0≤b≤0.5, 0≤c≤0.5, 0≤α≤2); LiaNi1-b-cMnbXcO2-αDα (0.90≤a≤1.8, 0≤b≤0.5, 0≤c≤0.5, 0≤α≤2); LiaNibCocL1dGeO2 (0.90≤a≤1.8, 0≤b≤0.9, 0≤c≤0.5, 0≤d≤0.5, 0≤e≤0.1); LiaNiGbO2 (0.90≤a≤1.8, 0.001≤b≤0.1); LiaCoGbO2 (0.90≤a≤1.8, 0.001≤b≤0.1); LiaMn1-bGbO2 (0.90≤a≤1.8, 0.001≤b≤0.1); LiaMn2GbO4 (0.90≤a≤1.8, 0.001≤b≤0.1); LiaMn1-gGgPO4 (0.90≤a≤1.8, 0≤g≤0.5); Li(3-f)Fe2(PO4)3 (0≤f≤2); and LiaFePO4 (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The separator 230 may be interposed between the first electrode plate 210 and the second electrode plate 220 to prevent short circuit between the first electrode plate 210 and the second electrode plate 220.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al2O3, SiO2, TiO2, SnO2, CeO2, MgO, NiO, Cao, GaO, ZnO, ZrO2, Y2O3, SrTiO3, BaTiO3, Mg(OH)2, boehmite, and combinations thereof but is not limited thereto.

The organic material and the inorganic material may be mixed in one coating layer or may be in the form of a coating layer containing an organic material and a coating layer containing an inorganic material that are laminated on each other.

The first insulating plate 300 may prevent the first electrode plate 210, which is a negative electrode, from being electrically connected to the bottom portion 110 of the can 100. The first electrode plate 210 may not be in direct contact with the bottom portion 110 as the first insulating plate 300 is provided between the first electrode plate 210 and the bottom portion 110. The first insulating plate 300 may have a first hole 310 in fluid communication with the core 240 and a second hole 320 through which the first electrode tab 250 may pass. If a large amount of gas is generated due to abnormality of the secondary battery, the first hole 310 may allow the gas to move upward through the core 240. The first electrode tab 250 may extend through the second hole 320 and be welded to the bottom portion 110.

The second insulating plate 400 may prevent the second electrode plate 220, which is a positive electrode, from being electrically connected to the cap assembly 500. That is, the second electrode plate 220 may not be in direct contact with the cap assembly 500 with the second insulating plate 400 positioned between the second electrode plate 220 and the cap assembly 500. The second insulating plate 400 may have a first hole 410 in fluid communication with the core 240 and a second hole 420 through which the second electrode tab 270 may pass. If a large amount of gas is generated due to abnormality of the secondary battery, the first hole 410 may allow the gas to move upward. A plurality of second holes 420 may be provided. The second hole 420 may also be an inlet through which the electrolyte is injected into the electrode assembly 200.

Although not shown in the figures, another current collection structure may be used in the secondary battery of the present embodiment. For example, the first uncoated portion and the second uncoated portion may be notched in a certain shape to serve as a first substrate tab and a second substrate tab, respectively. The first substrate tab and the second substrate tab may be electrically connected to a first current collection plate and a second current collection plate, respectively. The first current collection plate may be electrically connected to the can. The second current collection plate may be electrically connected to the cap assembly while being isolated from the can.

The cap assembly 500 may include a cap up 510, a vent plate 530, a cap down 550, and an insulator 570. The cap assembly 500 may be inserted between the beading part 132 and the crimping part 134 of the can 100 while an insulating gasket 600 is interposed therebetween. Each of the cap up 510, the vent plate 530, and the cap down 550 may be made of aluminum, an aluminum alloy, or an equivalent thereto. But the present disclosure is not limited to these examples.

The cap up 510 is an externally exposed part of the can 100, which may be disposed on the uppermost part of the cap assembly 500. he cap up 510 may be shaped, for example, as a convex protrusion of a part of a disc-shaped metal plate. The convex region may be a central region of the disc. The vent plate 530 may be disposed under the cap up 510. The vent plate 530 may be shaped to wrap around the edge of the cap up 510. For convenience, an edge region of the cap up 510 is referred to as a first region 512, a protruding region is referred to as a second region 514, and a sloping region between the first region 512 and the second region 514 is referred to as a third region 516. The second region 514 and/or the third region 516 may be provided with at least one discharge hole 518.

Referring to FIG. 3, a plurality of the discharge holes 518 may be provided in the second region 514. The discharge holes 518 may be formed through the second region 514 inclined relative to a normal direction (or normal vector direction) of the surface of the second region 514. The discharge hole 518 may be provided to face an upward direction at an inclined angle relative to an upper surface of the second region 514, rather than an upward direction (e.g., a normal direction) perpendicular to the upper surface of the second region 514. In such a case, the discharge holes 518 facing each other may be formed in diagonal directions that are opposite each other. For example, the right discharge hole 518 of FIG. 3 may be disposed to face the upper right at an angle of approximately 45 degrees to the upper surface of the second region 514 in sectional view. The left discharge hole 518 of FIG. 3 may be disposed to face the upper left at an angle of approximately 45 degrees to the upper surface of the second region 514 in sectional view. Thus, all of the discharge holes 518 may be disposed to discharge gas radially upwardly at 45 degree angles and circumferentially about the cap up 510. It should be noted that gas may not be discharged at an exact 45 degree angle because the gas is discharged and diffused but, the presence of discharge pressure may cause the gas to be discharged at an angle of approximately 45 degrees. In this case, a gas inspection sensor, a leak detection sensor, or a tape may be installed around the secondary battery 10 (in a battery module/pack) at position(s) that are not in line with the discharging gas. This may prevent damage or impact to the surrounding sensors due to gas discharge. In addition, since the gas is uniformly discharged at an angle of 45 degrees relative to the top of the secondary battery 10, the recoil direction of the gas discharge is toward the bottom of the secondary battery 10. The bottom of the secondary battery 10 may be fixed to the battery module/pack, thereby minimizing the recoil from the discharging gas. Thus, breakage of or damage to the secondary battery 10 due to recoil may be prevented.

The vent plate 530 may be provided in an approximately disc-shaped form, the edge of which may wrap around the first region 512 of the cap up 510. The edge of the vent plate 530 may wrap around the entire lower surface of the first region 512 and a part of the upper surface of the first region 512. Except for the part wrapping around the first region 512, the remaining region of the vent plate 530 may be located under the second region 514 of the cap up 510. For convenience, the part wrapping around the first region 512 of the cap up 510 is referred to as a first portion 532, and the part disposed under the second region 514 is referred to as a second portion 534. A contact portion 536 that contacts the cap down 550 may protrude from a lower surface of the first portion 532. Only the contact portion 536 is in contact with and electrically connected to the cap down 550. The other portions may be spaced apart from the cap down 550. To this end, the vent plate 530 may be shaped such that the second portion 534 is closer to the cap up 510 than the first portion 532. For example, the first portion 532 may protrude farther toward the cap down 550 than the second portion 534. At least one notch 538 may be provided so as to be spaced apart from the contact portion 536. The notch 538 may rupture when there is an increase in internal pressure of the secondary battery 10, thereby causing the vent plate 530 to open.

The cap down 550 may be disposed under the vent plate 530. The insulator 570 may be inserted between the cap down 550 and the vent plate 530. The cap down 550 may be disc shaped. The cap down 550 may support the cap up 510 to prevent deformation of the cap up 510 from external force. The cap 550 may contact only the contact portion 536 of the vent plate 530, while other parts may be spaced apart from the vent plate 530. To this end, the edge of the cap 550 may protrude toward the second portion 534 of the vent plate 530. The parts of the cap 550 other than the edge may protrude in a direction away from the first portion 532 of the vent plate 530. For convenience, the edge region of the cap down 550 may be referred to as a first support portion 552, and the central region of the cap down 550 may be referred as a second support portion 554. A part or the entirety of the second support portion 554 may be welded to the contact portion 536 of the vent plate 530. In addition, the thickness of the part or the entirety of the second support portion 554 welded to the contact portion 536 may be less than the thickness of the first support portion 552. At least one gas hole 556 may be formed through the second support portion 554. Thus, when the internal pressure of the secondary battery 10 increases, gas may be discharged to outside of the secondary battery 10 through the gas hole 556, the broken vent plate 530, and the discharge hole 518 of the cap up 510.

The insulator 570 may be made of an insulating material to keep the vent plate 530 and the cap down 550 spaced apart and insulated from each other. The insulator 570 may be disposed between the first support portion 552 of the cap down 550 and the first portion 532 of the vent plate 530. The insulator 570 may be in the form of a circular ring having a constant width when viewed from above. The length of the outer diameter minus the inner diameter of the insulator 570 may be less than or equal to the length of the outer diameter minus the inner diameter of the first support portion 552 of the cap down 550 (see FIG. 3). The insulator 570 may be made of, for example, polyethylene (PE), polypropylene (PP), polystyrene (PS), an ethylene-vinyl acetate copolymer (EVA), or an equivalent thereto. But the present disclosure is not limited to these examples. The insulator 570 may be coupled to the vent plate 530 and the cap down 550 by ultrasonic welding, laser welding, or fusion.

Hereinafter, a cap assembly of a secondary battery according to another embodiment of the present disclosure will be described. Detailed descriptions of the same configurations and features as the above-described embodiment will be omitted.

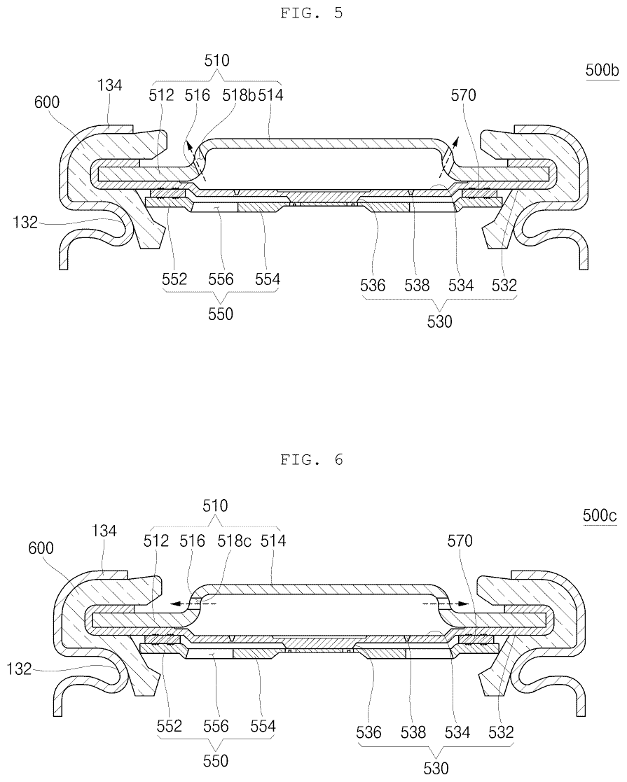

FIGS. 4 to 6 are enlarged sectional views of cap assemblies according to other embodiments of the present disclosure.

Referring to FIG. 4, a plurality of discharge holes 518 may be provided in the second region 514. The discharge holes 518 may be formed through the second region 514 at an inclination relative to a normal direction from the surface of the second region 514. In this case, all of the plurality of discharge holes 518 may be oriented in the same direction. All of the discharge holes 518 may be configured to face one side (e.g., the right side) at an angle of approximately 45 degrees to the upper surface of the second region 514 in sectional view. Thus, when gas is discharged, the discharge direction of the gas may be at an angle of approximately 45 degrees relative to the upper surface of the second region 514. Consequently, a sensor or the like may be installed such that it is not in line with the gas discharge direction. In addition, since the gas is uniformly discharged at an angle of approximately 45 degrees in a direction toward one side of the top of the secondary battery 10, the recoil direction due to the gas discharge is toward the left with reference to FIG. 4. Since the direction of recoil due to gas discharge may be known in advance, it is possible to make a design that prevents damage from the recoil. While in this example all of the discharge holes 518 are oriented 45 degrees upward toward the right of the secondary battery 10 with respect to FIG. 4, the present disclosure is not limited to such a configuration.

In the embodiments of FIGS. 3 and 4, the discharge holes 518 may be provided in the same shape. For example, the sectional shape of the discharge hole 518 may be a circular shape, a long hole shape, a slit shape having a certain length, or a polygonal shape. The number of discharge holes 518 may be two or more. The size of the discharge hole 518 may be varied within a range that does not cause deformation upon welding of a busbar to the first region 512 of the cap up 510. In addition, the discharge hole(s) 518 may be spaced apart from a weld region by at least 20% of the diameter of the weld region.

Referring to FIG. 5, the discharge holes 518 may be provided in the third region 516 of the cap up 510. For example, the discharge holes 518 may formed through a plate surface of the second region 514 of the cap up 510 so as to face upward at an angle of approximately 45 degrees. In other embodiments such as shown in FIG. 6, the discharge holes 518 may be formed through the plate surface of the second region 514 so as to face in a direction that is parallel to the plate surface. However, the discharge hole 518 may not be formed to face the bottom of the secondary battery 10. Therefore, a sensor or the like may be installed at a position that is not in line with the discharging gas. In addition, since the direction of recoil due to gas discharge may be known in advance, it is possible to design the battery to prevent damage from recoil is.

In the embodiments of FIGS. 5 and 6, the discharge holes 518 may be provided in the same shape. The number of discharge holes 518 may be two or more. The size of the discharge hole 518 may be varied within a range that does not cause deformation upon welding of the busbar to the second region 514 of the cap up 510. For example, the diameter of the discharge holes 518 may be determined to be within 50% of the length of the second region 514.

The secondary battery according to the above embodiments may be used to manufacture a battery pack.

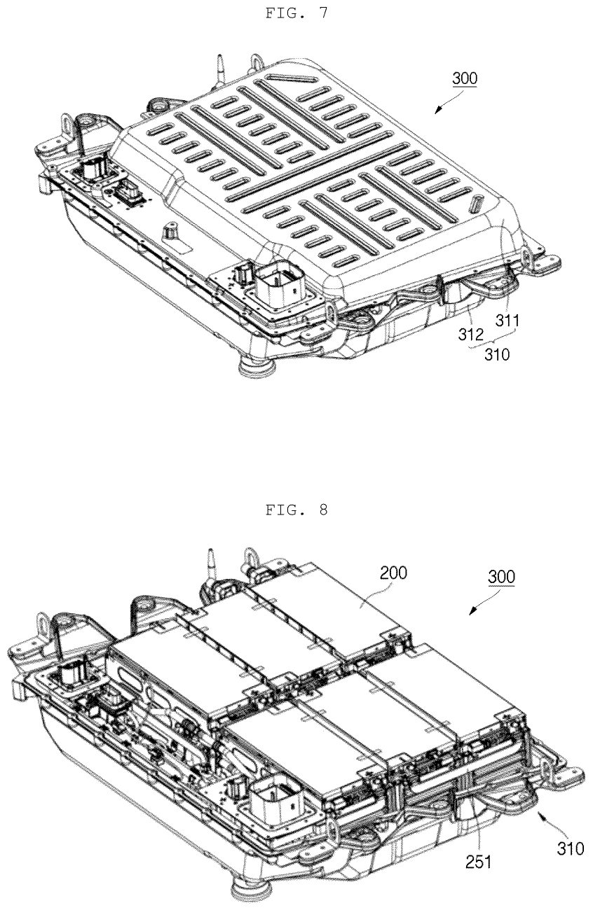

FIGS. 7 and 8 are perspective views showing a battery pack including an exemplary secondary battery according to the present disclosure.

Referring to FIGS. 7 and 8, the battery pack 300 may include a plurality of battery modules 200 and a housing 310 for accommodating the plurality of battery modules 200. For example, the housing 310 may include first and second housings 311 and 312 coupled in opposite directions through the plurality of battery modules 200. The plurality of battery modules 200 may be electrically connected to each other by using a bus bar 251, and the plurality of battery modules 200 may be electrically connected to each other in a series/parallel or series-parallel mixed method, thereby obtaining desired (e.g., required) electrical output. In the drawings, for convenience, components such as busbars for the electrical connection of battery cells, cooling units, and external terminals are omitted. In some examples, the battery pack (300) may be installed in a vehicle. The vehicle can be, for example, an electric vehicle, a hybrid vehicle, or a plug-in hybrid vehicle. The vehicle may include a four-wheel vehicle or a two-wheel vehicle.

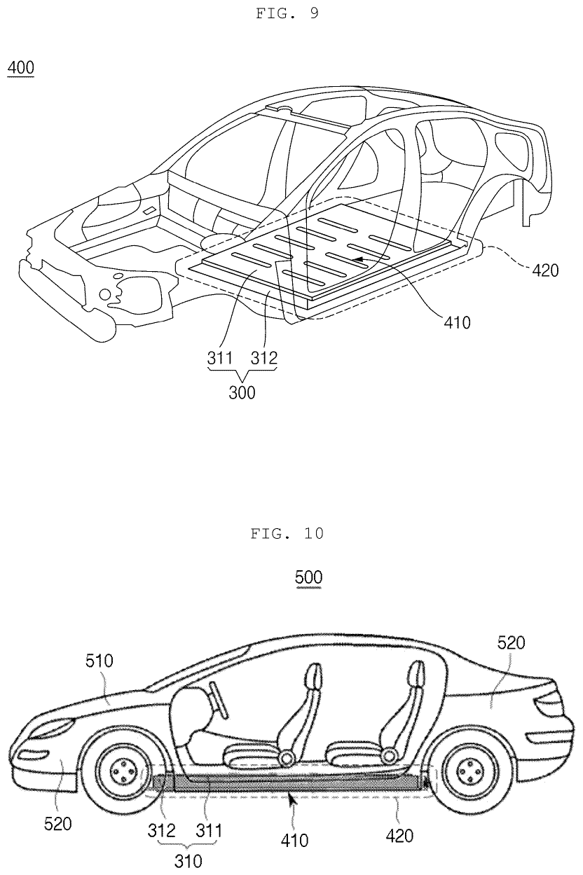

FIGS. 9 and 10 are perspective and side views of a vehicle including an exemplary battery pack according to the present disclosure.

FIGS. 9 and 10 are perspective and side views of automobiles 400 and 500 including an exemplary battery pack 300 according to the present disclosure. In FIG. 9, a battery pack 300 may include a battery pack cover 311, which is a part of a vehicle underbody 410 and may correspond to the first housing, and a pack frame 312, which is disposed under the vehicle underbody 410 and may corresponding to the second housing. The battery pack cover 311 and the pack frame 312 may be integrally formed with a vehicle floor 420. The vehicle underbody 410 separates the inside and outside of a vehicle, and the pack frame 312 may be disposed outside the vehicle.

In FIG. 10, a vehicle 500 may be formed by combining additional parts, such as a hood 510 in front of the vehicle 500 and fenders 520 respectively located in the front and rear of the vehicle 500 to a vehicle body pars 400. The vehicle 500 may include the battery pack 300 including the battery pack cover 311 and the pack frame 312, and the battery pack 300 may be coupled to the vehicle body part 400.

As is apparent from the above description, according to embodiments of the present disclosure, gas discharged to the outside through a cap up may be guided in a desired direction, whereby it is possible to attach a sensor at a desired that is not in line with the discharging gas. In addition, upon receiving recoil in the direction opposite to the gas discharge after a secondary battery is mounted in a vehicle or the like, it is possible to control the direction of the recoil, thereby preventing and controlling problems such as damage caused by the recoil.

However, aspects and features of the present disclosure are not limited to those described above, and other aspects and features not mentioned will be clearly understood by a person skilled in the art from the detailed description.

The present disclosure is not limited to the above-described embodiments, and a person having ordinary skill in the art to which the present disclosure pertains will recognize the technical spirit of the present disclosure to the extent that various modifications can be made without departing from the gist of the present disclosure.

What is claimed is:

1. A secondary battery comprising:
a cylindrical can;
an electrode assembly accommodated in the can; and
a cap assembly comprising a cap up exposed to outside of the can, a vent plate disposed under the cap up, at least a part of the vent plate being coupled to the cap up, and a cap down disposed under the vent plate, a part of the cap down being electrically connected to the vent plate and the electrode assembly, the cap assembly being coupled to an end of the can,
wherein a plurality of discharge holes is formed through at least one surface of the cap up so as to face in at least one predetermined direction.

2. The secondary battery as claimed in claim 1, wherein the vent plate is shaped to wrap around an edge of the cap up.

3. The secondary battery as claimed in claim 2, wherein the cap up comprises a first region in contact with the vent plate, a second region protruding outward from the first region, and a third region provided between the first region and the second region, with the third region being inclined relative to the first region and the second region.

4. The secondary battery as claimed in claim 3, wherein the discharge holes are provided in the second region.

5. The secondary battery as claimed in claim 4, wherein the discharge holes are formed in directions that are diagonal relative to a surface of the upper cap and are opposite each other.

6. The secondary battery as claimed in claim 4, wherein the discharge holes are formed in the same direction and diagonal relative to a surface of the cap up.

7. The secondary battery as claimed in claim 3, wherein the discharge holes are provided in the third region.

8. The secondary battery as claimed in claim 7, wherein the discharge holes are formed at angles relative to a direction that is normal to a surface of the second region.

9. The secondary battery as claimed in claim 8, wherein the discharge holes are formed so as to face upwardly from the cap up.

10. The secondary battery as claimed in claim 7, wherein the discharge holes are formed parallel to a direction that is normal to a surface of the second region.

11. A secondary battery comprising:
a can having a circular bottom portion and a cylindrical side portion extending from the bottom portion, the can having an open end opposite to the circular bottom portion;
an electrode assembly accommodated in the can; and
a cap assembly comprising a cap up exposed to outside of the can, a vent plate disposed under the cap up, at least a part of the vent plate being coupled to the cap up, and a cap down disposed under the vent plate, a part of the cap down being electrically connected to the vent plate and the electrode assembly, the cap assembly being coupled to the side portion at the open end of the can,
wherein a plurality of discharge holes is formed through at least one surface of the cap up so as to face in at least one direction.

12. The secondary battery as claimed in claim 11, wherein the vent plate is shaped to wrap around an edge of the cap up.

13. The secondary battery as claimed in claim 12, wherein the cap up comprises a first region in contact with the vent plate, a second region protruding outward from the first region, and a third region provided between the first region and the second region, with the third region being inclined relative to the first region and the second region.

14. The secondary battery as claimed in claim 13, wherein the discharge holes are provided in the second region.

15. The secondary battery as claimed in claim 14, wherein the discharge holes are formed at angles relative to a direction that is normal to a surface of the second region of the cap up and in directions that are opposite to each other.

16. The secondary battery as claimed in claim 14, wherein the discharge holes are formed in the same direction and at an angle relative to a direction that is normal to a surface of the second region.

17. The secondary battery as claimed in claim 13, wherein the discharge holes are provided in the third region.

18. The secondary battery as claimed in claim 17, wherein the discharge holes are formed at angles relative to a direction that is normal to a surface of the second region.

19. The secondary battery as claimed in claim 18, wherein the discharge holes are formed so as to face upwardly from the cap up.

20. The secondary battery as claimed in claim 17, wherein the discharge holes are parallel to a direction that is normal to a surface of the second region.
